(19) United States
(12) Patent Application Publication
(10) Pub. No.: US 2013/0279652 A1
(43) Pub. Date: Oct. 24, 2013

(54) MEASURING APPARATUS

(71) Applicant: HITACHI, LTD., Tokyo (JP)

(72) Inventors: Akira NAMBU, Yokohama-shi (JP); Kazuhiro UEDA, Kawagoe-shi (JP); Tsuyoshi YAMAMOTO, Kawagoe-shi (JP); Hideaki KOIZUMI, Tokyo (JP); Tomihiro HASHIZUME, Hatoyama-machi (JP)

(73) Assignee: HITACHI, LTD., Tokyo (JP)

(21) Appl. No.: 13/837,381

(22) Filed: Mar. 15, 2013

(30) Foreign Application Priority Data
Apr. 18, 2012 (JP) 2012-094467

(51) Int. Cl. G01N 23/083

(52) U.S. Cl. CPC G01N 23/083
USPC 378/45; 378/64; 378/53

(57) ABSTRACT

Provided is a measuring apparatus which is capable of measuring the distribution of a specific element in a specimen by soft X rays in a state where there is no effect by a staining agent and the like even though the specimen is composed of living single cells or cell aggregates living as they are, extracted in vitro from an organism. A measuring apparatus using soft X rays includes a connection part which is connected with a soft X ray beam line, a mechanism which light-collects a spot size of soft X rays into a micro beam, and a low vacuum vessel having a measurement chamber in which a specimen is disposed.

### CLAIM OF PRIORITY

The present application claims priority from Japanese patent application JP 2012-094467 filed on Apr. 18, 2012, the content of which is hereby incorporated by reference into this application.

### FIELD OF THE INVENTION

The present invention relates to a measuring apparatus using soft X rays.

### BACKGROUND OF THE INVENTION

X ray having low photon energy in a range from about 100 eV or less to about 2,000 eV and weak transmissivity is referred to as soft X ray, and there is practically no light source, which may change energy in the energy range successively, other than synchrotron radiation light.

Soft X rays in the range from 30 eV to 2,000 eV, which are obtained from the synchrotron, include the K-absorption edge of light elements constituting an organism, such as carbon (C), nitrogen (N), oxygen (O) and the like, and the L-absorption edge of transition metals such iron (Fe), cobalt (Co), nickel (Ni) and the like, and it is possible to detect these elements selectively.

Further, it is possible to make an element selective microscopic measurement which is element-sensitive and position-sensitive by using a micro beam which narrows the spot size of X-rays using a Kirkpatrick-Baez mirror, Fresnel zone plate and the like to approximately 1 micrometer and scanning a specimen with the micro beam.

It is known that some kinds of diseases, disorders and the like are caused when a specific element is accumulated in specific cells, and the visualization thereof is expected to lead to diagnosis of the disease and disorder. For example, the accumulation of copper in the liver and the accumulation of zinc in the pancreas are responsible for the carcinogenesis, but the accumulation of manganese in the brains is thought to be responsible for Parkinson's disease. In the application other than diseases, a difference in accumulation behaviors of cesium 133 and cesium 137, which are isotopes of cesium, in plant cells (vegetable) is also known.

Representative embodiments of a visualization technology of cells or organisms include scanning near field optical microscopy (see, for example, J-M. Kim, T. Hirose, S. Sugiyama, T. Ohtani and H. Muramatsu: Visualizing a hybridized PNA probe on a DNA molecule with near-field optical microscopy, Nano Letters, Vol. 4, pp 2091-2097 (2004): Non-Patent Document 1), but in most cases, images that highlight a target site are obtained by staining tissues with any staining agent, or subjecting tissues to fluorescent band treatment. On the contrary, when using energy selectively exciting the intrinsic characteristic absorption edge of each element with soft X rays, it is possible to visualize the distribution of an element in cells without performing a particular staining treatment and the like.

As illustrated in FIG. 7, soft X rays have such weak transmissivity that soft X rays may hardly transmit 1 cm of the atmosphere at 1 atm (760 Torr), and typical experiments of soft X rays are performed under ultrahigh vacuum (approximately 10⁻⁹ Torr or less). However, in order to measure cells or cell aggregates, the ultrahigh vacuum environment is not suitable. Accordingly, in order to measure cells or cell aggregates, it is required to maintain an experimental bath (measurement chamber) at atmospheric pressure (about 760 Torr) to approximately low vacuum (from 10 Torr to 0.1 Torr), and it is necessary to make any design about a beam line that induces radiation light from a synchrotron accelerator, an experimental bath in which a specimen is disposed, and the like. As a method of implementing the measurement, there is a method of partitioning a beam line and a measurement bath with a thin filter as in D. F. Ogletree, H. Bluhm, G. Lebedev. C. S. Fadley, Z. Hussain, M. Salmeron, Rev. Sci. Instrum. Vo. 73 pp 3872-3877 (2002) (Non-Patent Document 2).

### SUMMARY OF THE INVENTION

The present inventors have observed single or several tens to several hundreds of cells or cell aggregates living as they are, which are extracted in vitro from an organism with soft X rays, and reviewed the specification of a measuring apparatus for observing the abnormalities of cells and diagnosing cells. In order to observe cells living as they are by using soft X rays, it is necessary to control the specimen environment in a range from atmospheric pressure to low vacuum and irradiate a soft X ray having a diameter smaller than the specimen size. In Non-Patent Document 1, an effect of a staining agent on specimens is a concern. In addition, in Non-Patent Document 2, a specimen may be observed in a low vacuum state, but it is difficult to measure the distribution of a specific element in the specimen.

The present invention has been made in an effort to provide a measuring apparatus which is capable of measuring the distribution of a specific element in a specimen by soft X rays in a state where there is no effect by a staining agent and the like even though the specimen is composed of single cells or cell aggregates living as they are, extracted in vitro from an organism.

An embodiment of the present invention provides a measuring apparatus including: a connection part which is connected with a soft X ray beam line, a mechanism which light-collects a spot size of soft X rays incident from the beam line into a micro beam, and a low vacuum vessel having a measurement chamber in which a specimen irradiated by the light-collected soft X ray is disposed.

Further, another embodiment of the present invention provides a measuring apparatus including a connection part for being connected with a beam line of a soft X ray source, a mechanism which light-collects a spot size of soft X rays incident from the beam line into a micro beam, a low vacuum vessel which is connected with the beam line, a means for producing a low vacuum state of the low vacuum vessel, a means for dividing an inside of the low vacuum vessel into two or more measurement chambers, a means for dividing soft X rays such that soft X rays are irradiated on each of the insides of the divided low vacuum vessels, a specimen stage which mounts a specimen on each of the insides of the divided low vacuum vessels, and a mechanism which detects light elements such as B, C, N, O, F, Na, Mg, Al, Si, P, and S, or transition metal elements such as Mn, Fe, Co, Ni, Cu, and Zn in the specimen by irradiating the divided soft X rays on each of the specimens.

According to an aspect of the present invention, it is possible to provide a measuring apparatus which is capable of measuring the distribution of a specific element in a specimen by soft X rays in a state where there is no effect by a staining agent and the like even though the specimen is composed of single or several tens to several hundreds of cells or cell aggregates living as they are, extracted in vitro from an organism.

### BRIEF DESCRIPTION OF THE DRAWINGS

FIG. 1 is a conceptual view illustrating an example of a measuring apparatus according to a first embodiment;

FIG. 2 is a conceptual view illustrating another example of the measuring apparatus according to the first embodiment;

FIG. 3 is a conceptual view illustrating another example of the measuring apparatus according to the first embodiment;

FIG. 4 is a conceptual view for describing a specimen driving mechanism of a measuring apparatus according to a second embodiment and for describing transmitting method measurement in a measuring apparatus according to a third embodiment;

FIG. 5 is a conceptual view for describing electron yield method measurement and conversion electron yield method measurement in a measuring apparatus according to a fourth embodiment;

FIG. 6 is a conceptual view for describing fluorescence yield method measurement in a measuring apparatus according to a fifth embodiment;

FIG. 7 is a view illustrating a relationship between soft X ray transmission in the atmosphere of 1 cm at each pressure and energy; and

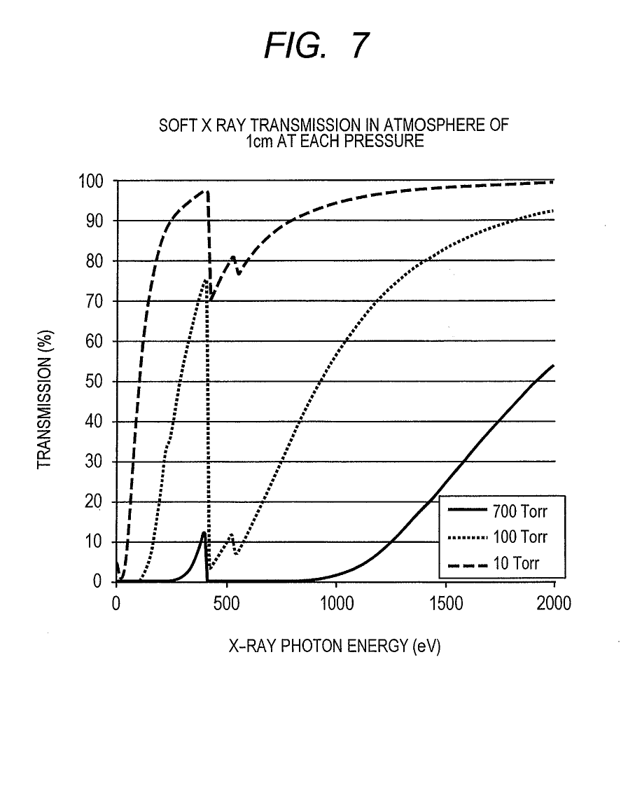

FIG. 8 is a conceptual view of a measuring apparatus according to an eleventh embodiment.

### DETAILED DESCRIPTION OF THE PREFERRED EMBODIMENTS

The present invention may specify the aggregation position of a specific element in cells or cell aggregates without using a staining agent and the like. Further, the present invention is characterized in changing conditions such as atmosphere, temperature, humidity, and the like during a process of incorporating a specific element species into the inside of a specimen, such as cells or cell aggregates placed in any atmosphere. Observation of difference in reactions to the ambient environment is also important.

In addition, it is possible to improve the throughput by enabling a plurality of specimens to be compared, measured, and observed simultaneously. For this reason, a system, which is capable of dividing an X ray optical path, inducing X rays into a measurement chamber under different conditions such as a plurality of atmospheres, temperatures, irradiances, and the like, and recording the temporal variation in cells or cell aggregates under different atmospheres, is constructed. As a means for dividing the soft X ray optical path, a method of using a thin Si film and the like as a half mirror, a method of extracting X rays expanded by using a dispersion mirror from a plurality of pinholes, and the like are contemplated.

Radiation light soft X rays (from 30 eV to 2,000 eV) obtained from a synchrotron radiation light source and the like are induced into a low vacuum region, which becomes a specimen chamber, through a differential pumping system or a thin film. In this case, in order to irradiate soft X rays on a specific spot in cells or cell aggregates, the beam diameters of soft X rays are reduced at the level of micro beam to approximately 1/10 of the sizes thereof (on the order to 1 μm) by using a Kirkpatrick-Baez mirror system, Fresnel zone plate, or the like.

In a scanning near field optical microscope which is often used in the observation of an organism specimen, and the like, an imaging of a specific molecule or element is performed by staining the specimen with a fluorescent staining agent. In the case of soft X rays used in the present invention, it is possible to achieve an imaging of the distribution of a specific element in cells without a chromosome by tuning the wavelength of the soft X rays into the absorption edge energy of the specific element. For this reason, it is possible to achieve an imaging of the element in cells in a state closer to an organism by preventing a staining agent from being intervened. Further, it is possible to simultaneously chase the time dependence of difference in reactions of cells or cell aggregates in a measurement chamber in which a plurality of conditions (atmosphere, temperature, humidity, and the like) are different by splitting X rays by an appropriate method. It is possible to diagnose a cell disorder, or detect abnormalities of cells placed at a specific atmosphere by measuring cells or cell aggregates using the apparatus.

Hereinafter, the present invention will be described in detail with reference with the embodiments.

### First Embodiment

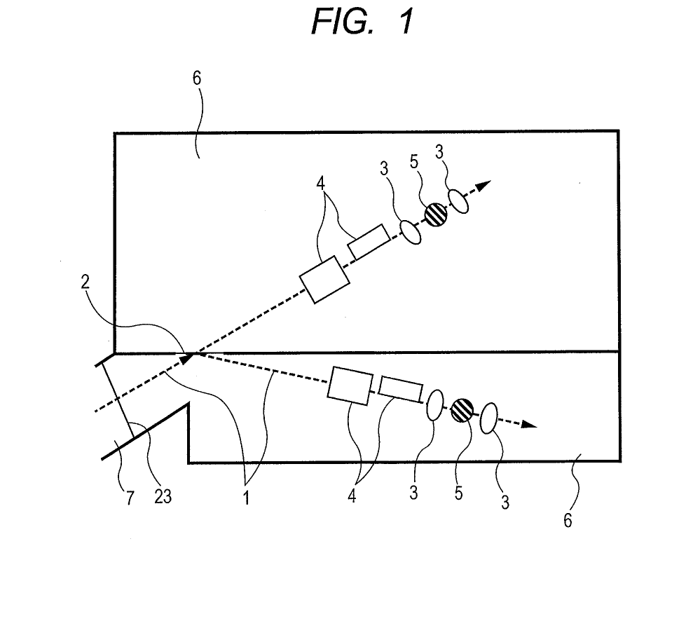

A first embodiment of the present invention will be described by using FIGS. 1, 2, and 3. FIGS. 1, 2, and 3 are schematic overall conceptual views illustrating an example of a measuring apparatus according to the embodiment, respectively. The apparatus includes a connection part 23 which is connected with a radiation light beam line 7 and the entire apparatus, a separation part (Si half mirror) 2 which separates an X ray into a plurality thereof, light collecting mechanisms 4 and 8 which reduces the X rays at the level of micro beam, and a measurement chamber 6 which performs an actual measurement. Further, reference numerals 1, 3, and 5 denote an X ray optical path, a metal mesh, and a specimen (cells, cell aggregates or the like), respectively. In each drawing, the same reference numeral indicates the same element.

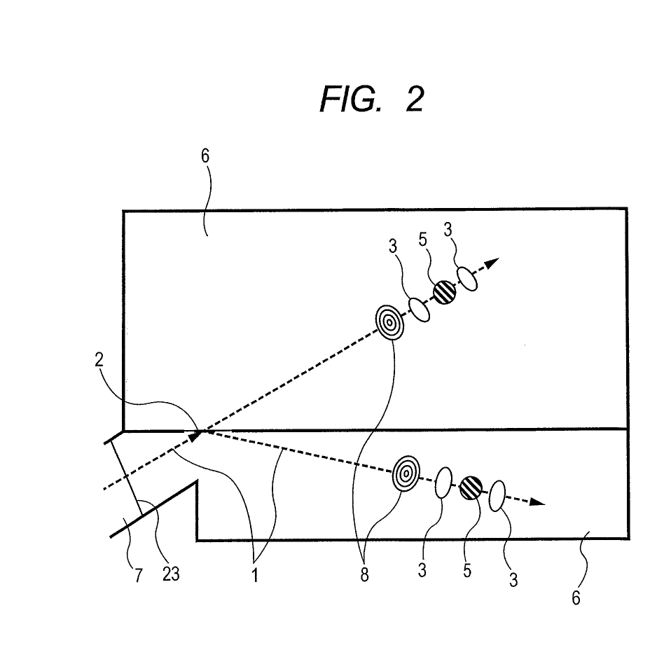

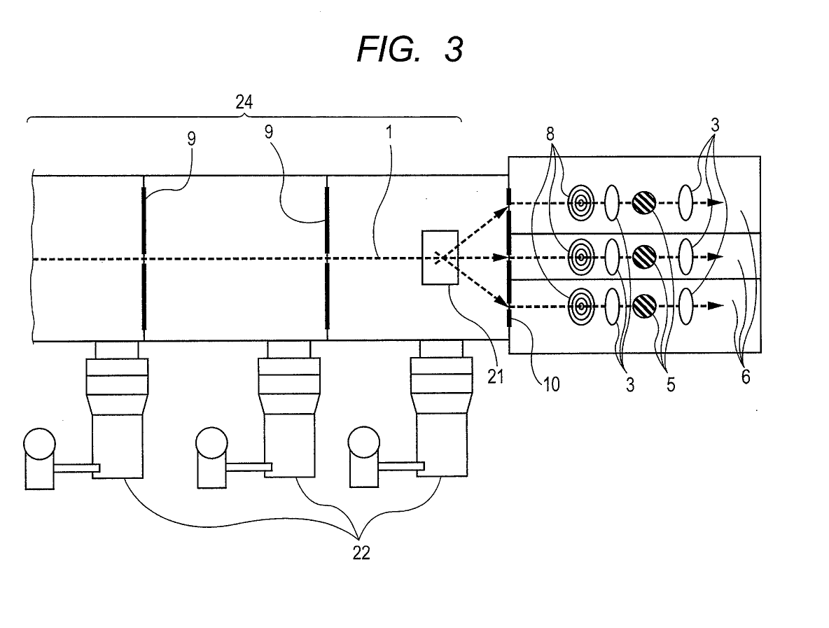

The connection part 23 is a part which connects a radiation light soft X ray beam line 7, which is maintained at ultrahigh vacuum (10⁻⁹ to 10⁻¹⁰ Torr), with a measurement chamber 6 which is maintained at low vacuum, and as the structure thereof, a method of achieving connection through a thin film such as Si, silicon nitride (Si₃N₄), Al and the like as illustrated in FIGS. 1 and 2, and a method of achieving connection by using a differential pumping system configured by pinholes and a vacuum pump and having a plurality of differential pumping chambers as illustrated in FIG. 3 are contemplated. In addition, it is possible to control the pressure of the differential pumping chamber at 10⁻⁷ to 10⁻⁴ Torr, and the pressure of the measurement chamber at atmospheric pressure to 10⁻³ Torr. Further, the diameters of pinholes are adjusted to several mm.

As a method of separating X rays by a separation part 2, a method of introducing transmitting X rays and reflected X rays into each measurement chamber by using a thin Si plate as illustrated in FIGS. 1 and 2, a method of irradiating X rays once expanded on a thin plate 10 with a plurality of holes (pinholes) perforated therein by using a dispersion mirror 21 as illustrated in FIG. 3 and inducing X rays passing through the holes into each separate measurement chamber, a method in combination thereof, and the like are contemplated. Further, reference numerals 9, 22, and 24 denote a thin plate having pinholes, pumps for differential pumping, and a differential pumping system including pinholes and pumping systems, respectively.

When a Si plate is used as the method of separating X rays, the thickness of the Si plate, the incident angle, and the like are suitably determined according to energy used. For example, in the case of a system as in FIG. 1, approximately 50% of X rays with 800 eV are reflected when the X rays are irradiated at an incident angle of 2.1 degrees on a Si plate having a thickness of 0.03 μm. In this case, an effective transmission path of transmitting X rays becomes 0.5 μm, and approximately 50% of X rays transmit the silicon plate.

In a method of using pinholes as the method of separating X rays, since X rays having a photon energy up to 2,000 eV may hardly transit a metal plate having a thickness of 10 μm or more, for example, as illustrated in FIG. 3, pinholes having a number corresponding to the number of measurement chambers may be prepared on a stainless steel plate 10 having a thickness of approximately 1 mm. The degree of vacuum may be varied step by step by using a differential pumping system, compared to the case of using the separation part 2.

For the light collecting mechanism, there are a method of using a Kirkpatrick-Baez mirror 4 composed of a set of two meridian curvature mirrors as illustrated in FIG. 1, and a method of using an X ray lens called a Fresnel zone plate 8 as illustrated in FIGS. 2 and 3. It is possible to adjust the degree of light collection independently according to the situation of each specimen chamber or specimen by providing the light collecting mechanism in each measurement chamber.

A measurement bath is formed of metal or other materials and is partitioned into several measurement chambers 6 therein, and a specimen 5 may be placed therein. A microscopic image is obtained by scanning the specimen 5 with the X rays which are reduced at the level of micro beam. Each measurement chamber 6 is maintained at approximately low vacuum and thus is pumped by a scroll pump, a diaphragm pump, and the like (not illustrated). In addition, it is possible to fill various gases (helium, argon, oxygen, nitrogen, and the like) or steam in a measurement bath and the like through a suitable valve (not illustrated). It is also possible to manipulate the ratio of the gas or steam for each measurement chamber.

It is possible to observe ingle or several tens to several hundreds of cells or cell aggregates living as they were, extracted in vitro from an organism, by using the measuring apparatus.

As described above, according to the embodiment, it is possible to provide a measuring apparatus which is capable of measuring the distribution of a specific element in a specimen by soft X rays in a state where there is no effect by a staining agent and the like even though the specimen is composed of living single cells or cell aggregates living as they are, extracted in vitro from an organism. Further, it is possible to simultaneously measure a plurality of specimens from the same object to be examined under different conditions or a plurality of specimens from different objects to be examined under the same condition simultaneously, by including a means for dividing soft X rays and a plurality of specimen chambers, thereby improving the throughput.

### Second Embodiment

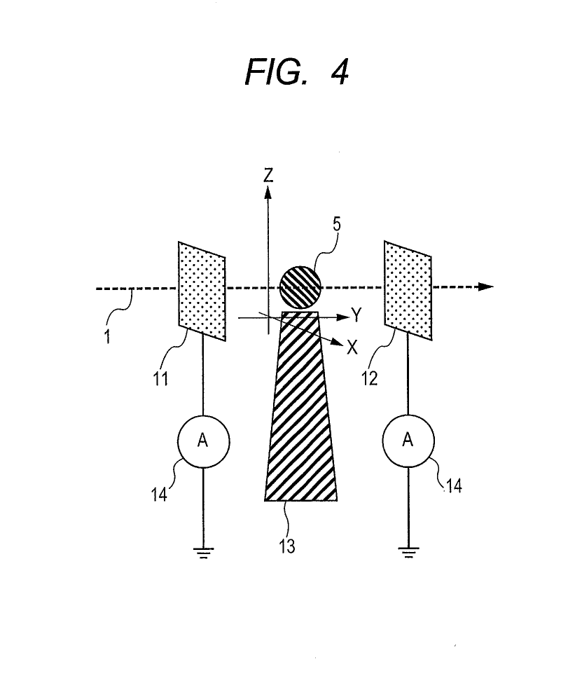

A second embodiment will be described by using FIG. 4. Further, what is described in the first embodiment but not described in the embodiment may also be applied to the embodiment as long as there is no particular circumstance. FIG. 4 is a schematic view of a major part for describing the measuring apparatus according to the embodiment.

A microscopic image may be obtained by irradiating X rays, which are reduced at the level of micro beam, on a specimen 5, scanning the specimen, and measuring different signal intensities depending on the position of the specimen 5. However, it is actually easier to move the specimen 5 than to move the X rays. Accordingly, in the embodiment, when the specimen 5 is fixed on a specimen stage 13 and the proceeding direction of the X rays is set to a Y-direction as illustrated in FIG. 4, the specimen stage 13 is scanned in an upward direction (Z-direction) vertical to the y-direction and a lateral direction (X-direction). The feed pitch of the specimen stage is set to 1/10 (0.1 μm) of the beam diameter of the X rays. The feed pitch may be used as long as the pitch is equal to or less than the beam diameter of the X rays, but is preferably ⅕ or less thereof.

In order to obtain a microscopic image with high precision, it is necessary to dispose the specimen 5 at the focal position of the X ray light-collected by a Kirkpatrick-Baez mirror or Fresnel zone plate. The focal position depends even on the degree of precision of manufacturing the Kirkpatrick-Baez mirror or Fresnel zone plate, and thus it is possible to adjust the position of the stage, which determines the position of each specimen, independently even in a direction parallel (Y) to the optical path of the X-rays, as illustrated in FIG. 4.

As a method of scanning the specimen stage 13 in each direction, it is possible to use a mechanism which generally moves a specimen, such as a micrometer, a piezo element, and the like. The manipulation may be independently performed on a plurality of measurement chambers. In this case, all of the driving mechanisms, which move the specimen stage 13, may be placed in a measurement chamber, and it is possible to use a method of adjusting the position of the stage in the measurement chamber through bellows and the like because some or all of the driving mechanisms are placed at places other than the measurement bath.

It is possible to observe ingle or several tens to several hundreds of cells or cell aggregates living as they were, extracted in vitro from an organism, by using the measuring apparatus.

As described above, it is possible to obtain an effect, which is the same as in the first embodiment, according to the embodiment. In addition, a microscopic image may be easily obtained from a simpler device configuration by scanning the specimen stage.

### Third Embodiment

A third embodiment will be described by using FIG. 4. Further, what is described in the first embodiment or second embodiment but not described in the embodiment may also be applied to the embodiment as long as there is no particular circumstance.

A cell image obtained in the present invention has the same meaning as measuring the position dependence of the absorption of X rays by cells. In general, the absorption of X rays by a material is represented by the following equation by defining the intensity of X ray before transmitting the material and the intensity of X ray after transmitting the material as I0 and I1, respectively. LN indicates a natural logarithm.

μ=LN(I1/I0) (1)

As a specific method of obtaining an image, as illustrated in FIGS. 1 and 4, a change caused by the position on cells or cell aggregates is measured at intensity I0 of X rays before transmitting the specimen and intensity I1 of X rays after transmitting the specimen by irradiating X rays, which are reduced at the level of micro beam, on the specimen 5 and scanning the surface of the specimen. Examples of the measurement of the intensity of X rays include a transmission measurement method of measuring photocurrent generated by irradiating X rays on metal meshes 11 and 12 formed of gold, copper and the like, which are placed in front and back of the specimen, as illustrated in FIGS. 1 and 4. Further, an ionization chamber may be used in measuring the intensity according to the energy of soft X rays. The distance between the specimen and the metal mesh was set to approximately 1 cm. In addition, reference numeral 14 indicates an ampere meter.

It was possible to observe Single or several tens to several hundreds of cells or cell aggregates living as they were, extracted in vitro from an organism, by using the measuring apparatus.

As described above, it is possible to obtain an effect, which is the same as in the first embodiment or second embodiment, according to the embodiment. In addition, it is possible to obtain a microscopic image, which is not affected by a variation in intensity of X rays, by disposing metal meshes for measurement in front and back of the specimen in the proceeding direction of X rays.

### Fourth Embodiment

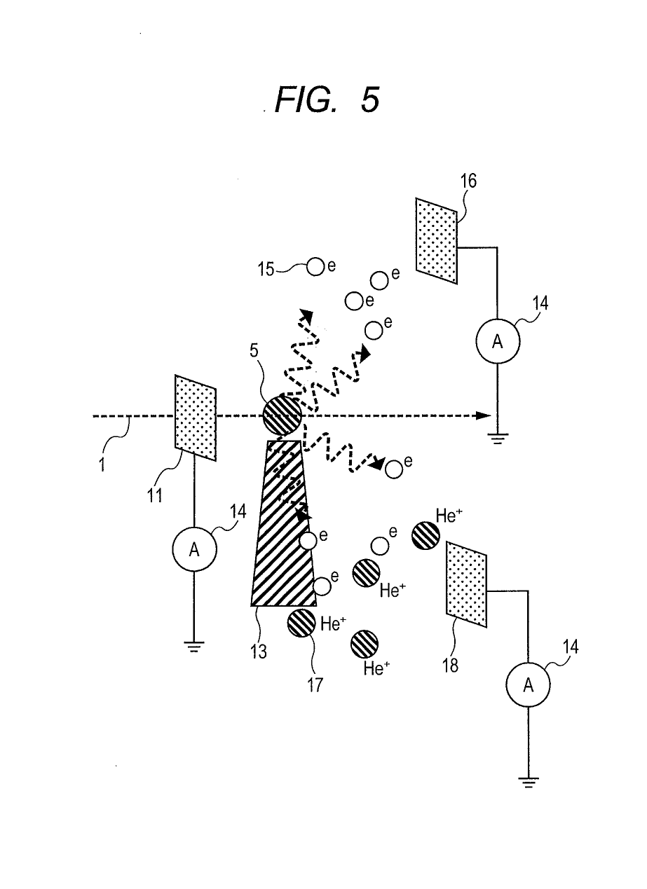

A fourth embodiment will be described by using FIG. 5. Further, what is described in the first embodiment or second embodiment but not described in the embodiment may also be applied to the embodiment as long as there is no particular circumstance. FIG. 5 is a schematic view of a major part for describing the measuring apparatus according to the embodiment.

A method of obtaining a second microscopic image is the same as the method in the third embodiment until X rays reduced at the level of micro beam are irradiated on the specimen, the surface of the specimen is scanned, and the intensity of X rays before transmitting the specimen is measured by photocurrent from a metal mesh formed of gold, copper, or the like, but an electron yield method of measuring the amount of photoelectron (external photoelectron) 15 released from the specimen by irradiation of X rays and using the intensity as I1 is also used for measuring the absorption amount of X rays. In order to measure the amount of photoelectron, the intensity is used as an electron yield grid 16 by disposing metal meshes or metal plates 16 and 18 around the specimen 5 and applying a positive pressure thereto. When it is difficult to directly obtain electrons, it is also possible to use a conversion electron yield method of measuring positive ion 17, which is obtained by ionizing gas molecules around the specimen by the released electron, as ion yield grid=18 and using the intensity as I1 likewise. In this case, a negative voltage is applied to the electron yield grid in a manner opposite to the case of electrons. When a conversion electron yield method is used, the atmosphere around the specimen may be air, but the method may also be performed under an atmosphere such as helium, argon, or the like. However, the absorption amount at this time is represented by the following equation, not Equation (1).

μ=I1/I0 (2)

It was possible to observe single or several tens to several hundreds of cells or cell aggregates living as they were, extracted in vitro from an organism, by using the measuring apparatus.

As described above, according to the embodiment, it is possible to obtain an effect, which is the same as in the first to third embodiments, from a specimen which is too thick for the X rays to transmit.

### Fifth Embodiment

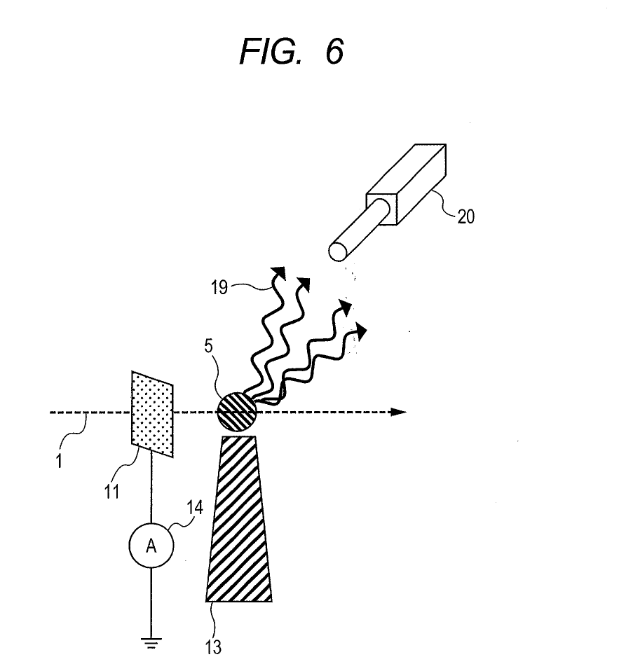

A fifth embodiment will be described by using FIG. 6. Further, what is described in the first embodiment or second embodiment but not described in the embodiment may also be applied to the embodiment as long as there is no particular circumstance. FIG. 6 is a schematic view of a major part for describing the measuring apparatus according to the embodiment.

A method of obtaining a third microscopic image is the same as the method in the third embodiment until X rays reduced at the level of micro beam are irradiated on the specimen, the surface of the specimen is scanned, and the intensity of X rays before transmitting the specimen is measured by photocurrent from a metal mesh formed of gold, copper, or the like, but a fluorescence yield method of using the amount of fluorescent X rays 19, which are released from the specimen by irradiation of X rays, as I1 may also be used for measuring the absorption amount of X rays. As a fluorescent X ray detector 20, it is possible to use a photodiode, a silicon drift director, a solid X ray detector, and the like. Even in this case, Equation 2 is used for calculating the absorption amount. Further, the distance between the specimen and the detector was set to approximately 1 cm.

It was possible to observe single or several tens to several hundreds of cells or cell aggregates living as they were, extracted in vitro from an organism, by using the measuring apparatus.

As described above, according to the embodiment, it is possible to obtain an effect, which is the same as in the first to third embodiments, even when a specimen is too thick for the x rays to transmit as in the fourth embodiment.

### Sixth Embodiment

A sixth embodiment will be described. Further, what is described in any one of the first to fifth embodiments but not described in the embodiment may also be applied to the embodiment as long as there is no particular circumstance.

Even in any of the first to fifth embodiments, it is possible to achieve the visualization without a process of staining the distribution of a specific element in cells or cell aggregates, which are a specimen by fitting the energy of soft X rays obtained from radiation light in the absorption edge of the specific element.

It was possible to observe single or several tens to several hundreds of cells or cell aggregates living as they were, extracted in vitro from an organism, by using the measuring apparatus.

As described above, it is possible to obtain an effect, which is the same as in the first to third embodiments, according to the embodiment. In addition, it is possible to visualize the distribution of a specific element by fitting the energy of soft X rays obtained from radiation light in the absorption edge of the specific element.

### Seventh Embodiment

A seventh embodiment will be described. Further, what is described in any one of the first to fifth embodiments but not described in the embodiment may also be applied to the embodiment as long as there is no particular circumstance.

Even in any of the first to fifth embodiments, the beam line, which induces X rays, is maintained under ultrahigh vacuum, but it is possible to maintain the measurement chamber at a pressure which is at approximately low vacuum, connect an arbitrary gas through a plurality of valves and the like, and control the atmosphere. Further, in a measurement chamber which is divided into a plurality of chambers as in FIGS. 1, 2 and 3, it is possible to change the atmosphere in each measurement chamber. In particular, when the object is cells or cell aggregates, it is important to suppress moisture from being evaporated, and it is possible to control the humidity in the measurement chamber through a valve.

It was possible to observe single or several tens to several hundreds of cells or cell aggregates living as they were, extracted in vitro from an organism, by using the measuring apparatus.

As described above, it is possible to obtain an effect, which is the same as in the first to seventh embodiments, according to the embodiment. In addition, it is possible to suppress moisture from being evaporated from cells or cell aggregates by controlling the humidity of the measurement chamber.

### Eighth Embodiment

An eighth embodiment will be described. Further, what is described in any one of the first to fifth embodiments but not described in the embodiment may also be applied to the embodiment as long as there is no particular circumstance.

Even in any of the first to fifth embodiments, it is possible to set the measurement conditions, such as temperature in an adjusting chamber, irradiation of visible light having a specific wavelength on a specimen, and the like for each measurement chamber, other than the atmosphere in the measurement chamber. Further, when visible lights are irradiated, it is also possible to adjust the intensity thereof for each chamber.

It was possible to observe single or several tens to several hundreds of cells or cell aggregates living as they were, extracted in vitro from an organism, by using the measuring apparatus.

As described above, it is possible to obtain an effect, which is the same as in the first to seventh embodiments, according to the embodiment.

### Ninth Embodiment

A ninth embodiment will be described. In addition, what is described in any one of the first to eighth embodiments but not described in the embodiment may also be applied to the embodiment as long as there is no particular circumstance.

Each of the atmosphere state, temperature, light intensity and the like of each measurement chamber, which are described in the seventh and eighth embodiments, is monitored by a sensor (atmosphere sensor, temperature sensor, and optical sensor) and the like, which corresponds to each measurement chamber. It is possible to maintain the state of the atmosphere (oxygen concentration, carbon dioxide concentration, or other gasses), temperature, light intensity and the like at a constant level during the measurement by using this information as a feedback, and to automatically change the state during the measurement according to a predetermined schedule. These sensors may be used alone or in combination thereof.

It was possible to observe single or several tens to several hundreds of cells or cell aggregates living as they were, extracted in vitro from an organism, by using the measuring apparatus.

As described above, it is possible to obtain an effect, which is the same as in the first to seventh embodiments, according to the embodiment. Further, it is possible to maintain the state in each measurement chamber at a constant level by providing various sensors in the measurement chamber. In addition, it is possible to change the state to a desired condition.

### Tenth Embodiment

A tenth embodiment will be described. Further, what is described in any one of the first to ninth embodiments but not described in the embodiment may also be applied to the embodiment as long as there is no particular circumstance.

An object to be measured is not limited to a bio specimen, and for example, it is possible to use the method even in the measurement of the distribution of phosphorus (P), sulfur (S) or the like in soil, the measurement of the charge distribution of a transition metal in a positive electrode agent among electrode materials while being wet with an electrolyte, and the like. It is possible to detect a light element such as B, C, N, O, F, Na, Mg, Al, Si, P, S and the like, or a transition metal such as Mn, Fe, Co, Ni, Cu, Zn, and the like in a specimen by irradiating soft X rays on the specimen.

It was possible to measure the distribution of phosphorus (P), sulfur (S) or the like in soil, the charge distribution of a transition metal in a positive electrode agent among electrode materials while being wet as an electrolyte, and the like, by using the measuring apparatus.

As described above, according to the embodiment, it is possible to provide a measuring device which is capable of measuring the distribution of a specific element in a specimen by soft X rays in a state where there is no effect by a staining agent in spite of a wet specimen.

### Eleventh Embodiment

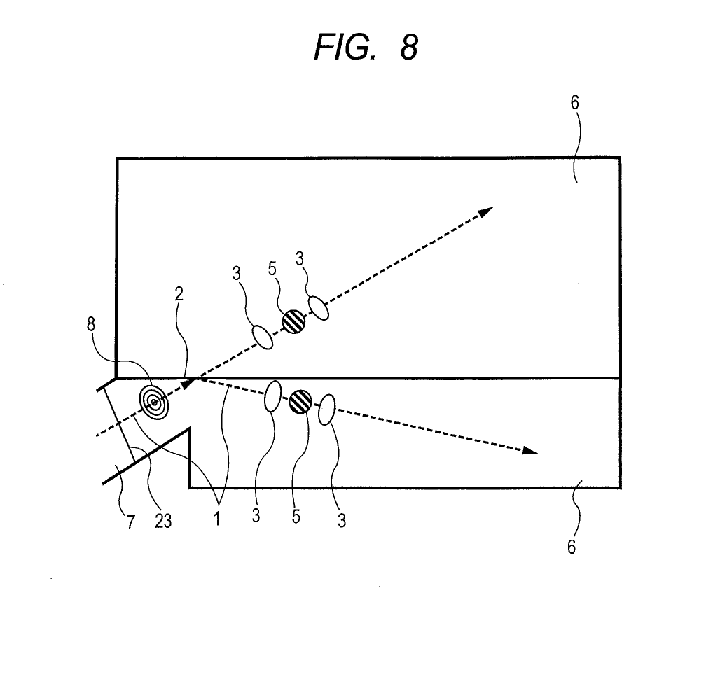

An eleventh embodiment will be described by using FIG. 8. Further, what is described in any one of the first to tenth embodiments but not described in the embodiment may also be applied to the embodiment as long as there is no particular circumstance. FIG. 8 is a schematic overall configuration view of the measuring apparatus according to the embodiment.

In particular, when a Kirkpatrick-Baez mirror is used only for division of soft X rays and reduction of soft X rays at the level of micro beam, the first and second embodiments show a sequence of dividing soft X rays and then reducing soft X rays at the level of micro beam, but it is also possible to use a method of reducing soft X rays at the level of micro beam by the Fresnel zone plate 8, and then using X rays, as illustrated in FIG. 8. In the case of this configuration, the number of zone plates may be decreased.

It was possible to observe single or several tens to several hundreds of cells or cell aggregates living as they were, extracted in vitro from an organism, by using the measuring apparatus. It was possible to measure the distribution of phosphorus (P), sulfur (S) or the like in soil, the charge distribution of a transition metal in a positive electrode agent among electrode materials while being wet as an electrolyte, and the like.

As described above, it is possible to obtain an effect, which is the same as in the first to tenth embodiments, according to the embodiment.

Further, the present invention is not limited to the aforementioned embodiments, and includes various modified embodiments. For example, the aforementioned embodiments have been described in detail for better understanding of the present invention, and are not always limited to inclusion of all elements described. In addition, it is also possible to substitute some configurations of any embodiment with a configuration of another embodiment, and to add a configuration of another embodiment to the configuration of any embodiment. Further, it is possible to add, delete, and substitute another configuration with respect to some configurations of each embodiment.

What is claimed is:

1. A measuring apparatus comprising:
a connection part which is connected with a soft X ray beam line,
a mechanism which light-collects a spot size of soft X rays incident from the beam line into a micro beam, and
a low vacuum vessel having a measurement chamber in which a specimen irradiated by the light-collected soft X ray is disposed.

2. The measuring apparatus according to claim 1, further comprising: a means for dividing the soft X rays such that it is possible to irradiate the soft X rays on the plurality of measurement chambers,
wherein the soft X rays are synchrotron radiation light which generates a photon energy from 30 eV to 2,000 eV, and
the low vacuum vessel includes a plurality of measurement chambers.

3. The measuring apparatus according to claim 2, wherein the means for dividing the soft X rays is a half mirror composed of a thin plate.

4. The measuring apparatus according to claim 3, wherein the thin plate is a Si thin plate.

5. The measuring apparatus according to claim 2, wherein the means for dividing the soft X rays is a metal plate on which a plurality of pinholes is formed.

6. The measuring apparatus according to claim 5, wherein the metal plate is a stainless steel plate having a thickness of approximately 1 mm, and
the pinholes have a diameter of several mm.

7. The measuring apparatus according to claim 1, wherein the mechanism which light-collects the spot size of the soft X rays into the micro beam is a Kirkpatrick-Baez mirror.

8. The measuring apparatus according to claim 1, wherein the mechanism which light-collects the spot size of the soft X rays into the micro beam is a Fresnel zone plate.

9. The measuring apparatus according to claim 1, wherein each of the plurality of measurement chambers comprises an adjusting mechanism of independently adjusting at least any one of pressure, humidity, oxygen concentration, carbon dioxide concentration, or other gasses.

10. The measuring apparatus according to claim 1, wherein each of the plurality of measurement chambers comprises a mechanism of adjusting a temperature or a mechanism of irradiating visible lights on the specimen, and an adjusting mechanism of independently adjusting a temperature or an amount of visible lights irradiated.

11. The measuring apparatus according to claim 1, wherein the plurality of measurement chambers comprises at least one of an atmosphere sensor, a temperature sensor, and a light intensity sensor.

12. A measuring apparatus comprising:
a connection part which is connected with a beam line of a soft X ray source,
a mechanism which light-collects a spot size of soft X rays incident from the beam line into a micro beam,
a low vacuum vessel which is connected with the beam line,
a means for producing a low vacuum state of the low vacuum vessel,
a means for dividing an inside of the low vacuum vessel into two or more measurement chambers,
a means for dividing soft X rays such that each X ray is irradiated on each of the insides of the divided low vacuum vessels,
a specimen stage which mounts a specimen on each of the insides of the divided low vacuum vessels, and
a mechanism of detecting a light element which is B, C, N, O, F, Na, Mg, Al, Si, P, and S, or a transition metal element which is Mn, Fe, Co, Ni, Cu, and Zn in the specimen by irradiating the divided soft X ray on each of the specimens.

13. The measuring apparatus according to claim 12, wherein the specimen stage is operated in upper and lateral directions to a proceeding direction of the soft X rays, such that a 2-dimensional image of the specimen is obtained.

14. The measuring apparatus according to claim 12, wherein the 2-dimensional image highlights a distribution of a specific element by fitting a wavelength of the soft X ray into an absorption edge of any one of the elements, in measuring an absorption amount of the soft X ray.

15. The measuring apparatus according to claim 14, wherein a transmission method, an electron yield method, a conversion electron yield method, or a fluorescence yield method is used for measuring an absorption amount of the soft X ray.
